(19) United States
(12) Patent Application Publication
(10) Pub. No.: US 2018/0103797 A1
(43) Pub. Date: Apr. 19, 2018

(54) Grilling Tool

(71) Applicant: George Morales, New River, AZ (US)

(72) Inventor: George Morales, New River, AZ (US)

(21) Appl. No.: 15/785,112

(22) Filed: Oct. 16, 2017

Related U.S. Application Data
(60) Provisional application No. 62/408,508, filed on Oct. 14, 2016.

(51) Int. Cl. A47J 37/04; A47J 36/02

(52) U.S. Cl. CPC A47J 37/04; A47J 36/02

(57) ABSTRACT

A grilling tool. The grilling tool includes a planar base having an upper surface, wherein the planar base comprises a stone material. A plurality of skewers extend perpendicularly away from the upper surface, wherein the plurality of skewers taper from a first end thereof towards a second end thereof.

### CROSS REFERENCE TO RELATED APPLICATIONS

This application claims the benefit of U.S. Provisional Application No. 62/408,508 filed on Oct. 14, 2016. The above identified patent application is herein incorporated by reference in its entirety to provide continuity of disclosure.

### BACKGROUND OF THE INVENTION

The present invention relates to grilling tools. Specifically, it relates to grilling tools having a plurality of skewers extending from a planar base comprising a stone material, such that heat is evenly distributed throughout a food item placed on the skewers.

Evenly grilling meat to a desired temperature can be a difficult and time-consuming process. Cooking foods below the desired temperature can result in serious and dangerous health effects, as undercooked foods can contain bacteria responsible for causing harmful illnesses. Additionally, overcooking foods, such as meat leads to dry, tough, and bland foods, which is also undesirable. Current methods to cook foods to a desired temperature include cutting meat to view the temperature profile of the internal portion of the meat, which causes juices within the meat to drain out, further leading to dry and tough food. Other methods involve touch testing the meat, however this can be difficult for average grillers, as accurately determining the temperature of meat by touch requires a considerable amount of experience. Alternatively, other grillers merely guess as to when the food is cooked to the desired temperature, frequently leading to either overcooked or undercooked food. Grilling devices known in the art utilizing skewers merely hold the food in a desired position while grilled, rather than evenly distributing heat through the food, leading to the griller using one of the above described lacking methods of determining when the food is at the desired temperature. Therefore, there is a need in the art for a grilling tool that allows an amateur griller to evenly cook meat on a consistent basis.

In light of the devices disclosed in the known art, it is submitted that the present invention substantially diverges in design elements from the known art and consequently it is clear that there is a need in the art for an improvement to existing grilling tools. In this regard, the instant invention substantially fulfills these needs.

### SUMMARY OF THE INVENTION

In view of the foregoing disadvantages inherent in the known types of grilling tools now present in the prior art, the present invention provides a grilling tool wherein the same can be utilized for providing convenience for the user when grilling food products with evenly distributed heat transfer therethrough.

The present system comprises a planar base having an upper surface, wherein the planar base comprises a stone material. A plurality of skewers extend perpendicularly away from the upper surface, the plurality of skewers tapering from a first end thereof towards a second end thereof. In some embodiments, the plurality of skewers are distributed across the upper surface in a grid pattern. In another embodiment, the plurality of skewers are distributed across the upper surface in a staggered grid pattern. In other embodiments, a handle extends from a first side of the planar base. In yet another embodiment, the handle further comprises a heat insulated gripping area thereon. In some embodiments, the plurality of skewers comprise copper, tungsten, aluminum, or an alloy thereof. In another embodiment, the planar base comprises an igneous stone material.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the grilling tool.

FIG. 2 shows a perspective view of an alternate embodiment of the grilling tool.

FIG. 3 shows a perspective view of an embodiment of the grilling tool in use.

FIG. 4 shows a close-up view of a skewer of an embodiment of the grilling tool radiating heat.

### DETAILED DESCRIPTION OF THE INVENTION

Reference is made herein to the attached drawings. Like reference numerals are used throughout the drawings to depict like or similar elements of the grilling tool. The figures are intended for representative purposes only and should not be considered to be limiting in any respect.

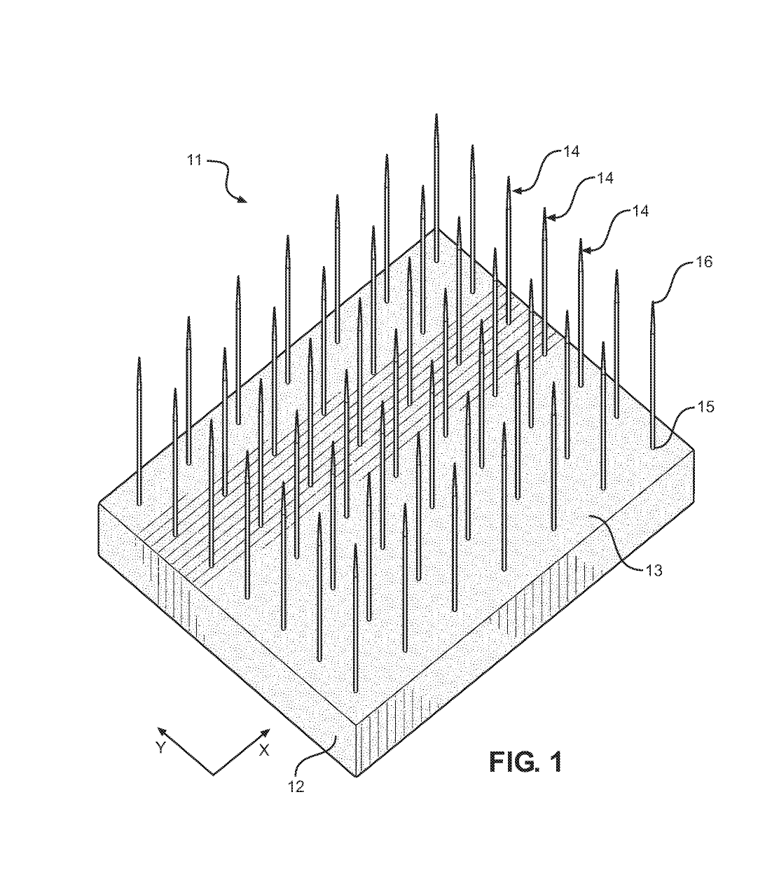

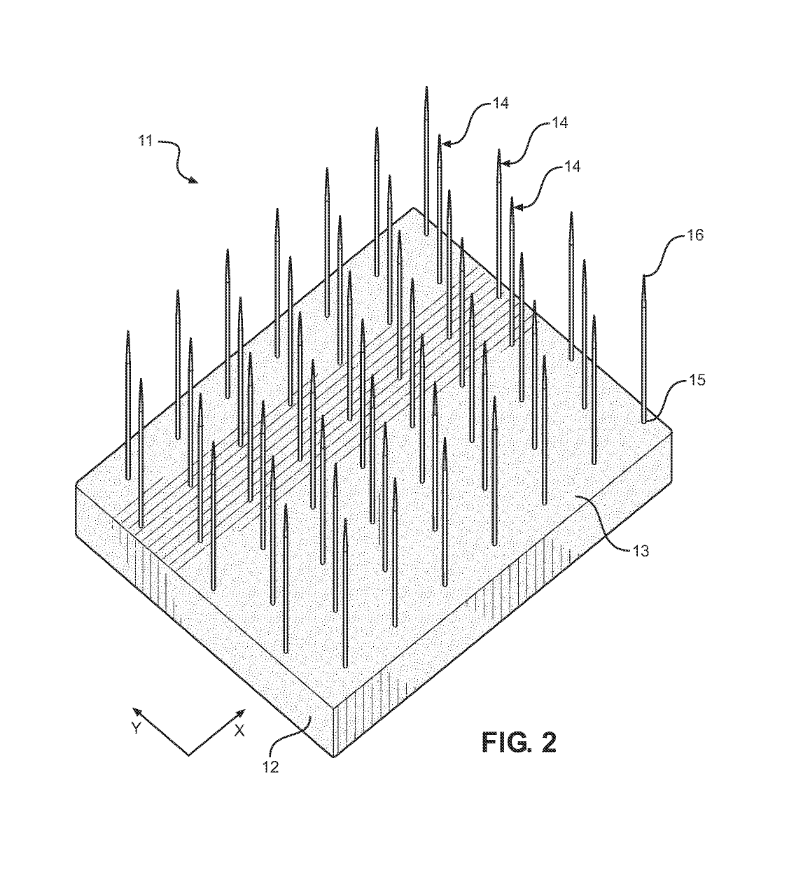

Referring now to FIGS. 1 and 2, there is shown a perspective view of an embodiment of the grilling tool and a perspective view of an alternate embodiment of the grilling tool, respectively. The grilling tool 11 comprises a planar base 12, wherein the planar base 12 comprises a stone material so as to provide a large thermal mass allowing minimal variances in temperature as heat is transferred from the planar base 12. In the illustrated embodiment, the planar base 12 comprises a rectangular cross-section, however other cross-sections, such as circular, oblong, and the like are contemplated. The planar base 12 further comprises an upper surface 13, wherein a plurality of skewers 14 extend perpendicularly away from the upper surface 13. The plurality of skewers 14 taper from a first end 15 of the skewers 14 towards a second end 16 of the skewers 14. In the illustrated embodiment, the plurality of skewers 14 taper from a point along the length of the skewers 14 towards the second end 16, however, in alternate embodiments, the skewers 14 taper along the entire length of the skewers 14 towards the second end 16 thereof. In this way, the plurality of skewers 14 taper to a point, allowing an item of food to be pierced thereby, securing the food to the grilling tool 11.

In the illustrated embodiments, the plurality of skewers 14 are evenly distributed across the upper surface 13. In this way, heat can be evenly transferred into a food item disposed thereon, ensuring appropriate doneness throughout. Various patterns of distribution can serve to provide differing benefits. For example, in the illustrated embodiment of FIG. 1, the plurality of skewers 14 are distributed across the upper surface 13 in a regular grid pattern, wherein the plurality of skewers 14 are arranged in rows along the X axis and columns along the Y axis. In the grid pattern of FIG. 1, each skewer 14 in adjacent rows are aligned within a column, and each skewer 14 in adjacent columns are aligned within a row. Additionally, adjacent rows and adjacent columns are separated by an equal distance. The grid pattern allows an even distribution of heat throughout a food item disposed on the skewers 14. In the alternate embodiment of FIG. 2, the plurality of skewers 14 are distributed across the upper surface 13 in a staggered grid pattern, wherein adjacent rows are offset, such that alternating rows are not aligned within the same column. The staggered grid pattern also provides an even distribution of heat transfer, however, the staggered arrangement of the plurality of skewers 14 allows food to be placed therebetween, such that while cooking food pierced by the skewers 14, additional food items, such as vegetables, can be placed directly on the upper surface 13. In this way, heat is transferred directly to the additional food items, while the skewers 14 prevent the additional food items from rolling or otherwise moving from between the skewers 14 as the grilling tool 11 is moved.

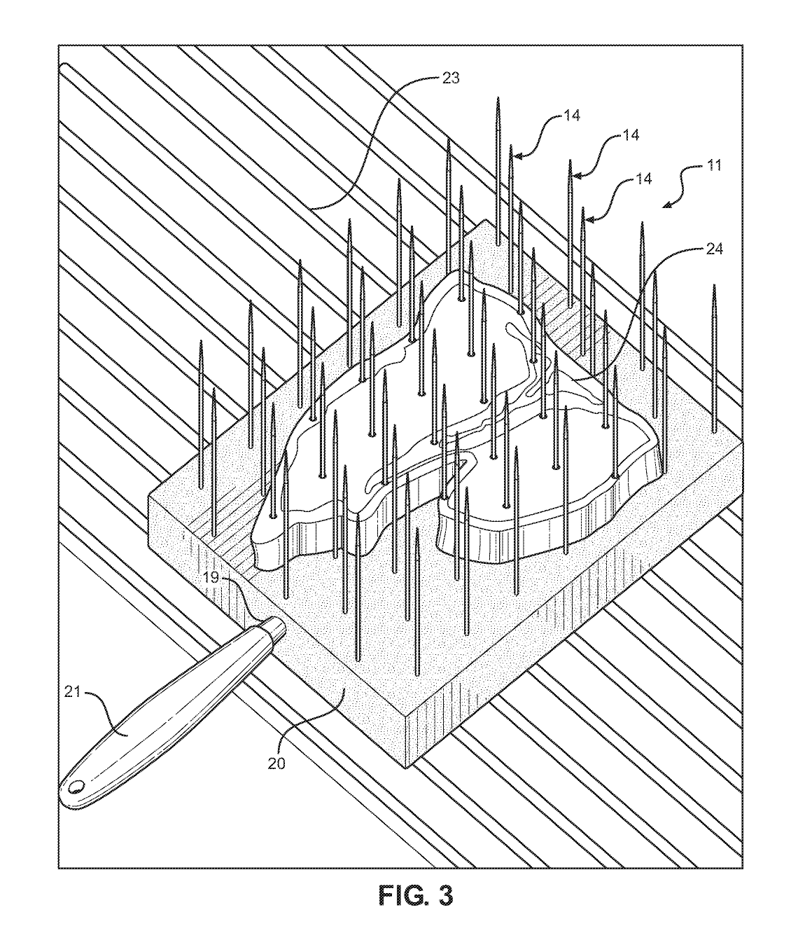

Referring now to FIG. 3, there is shown a perspective view of an embodiment of the grilling tool in use. In the illustrated embodiment, the grilling tool 11 further comprises a handle 19 extending from a first side 20 of the planar base. The handle provides the user with a gripping surface to maneuver the grilling tool 11 when in use. In the illustrated embodiment, the handle 19 further comprises a heat insulated grip 21, surrounding the handle 19. The heat insulated grip 21 prevents heat that has transferred into the handle 19 from the planar base from transferring into the user as the handle is gripped. The heat insulated grip 21 can comprise a variety of heat insulating materials, such as, but not limited to, silicon and rubber.

In one exemplary use, a food item 24, such as a steak or other meat product, is pierced by the plurality of skewers 14 such that the food item 24 is removably secured to the grilling tool 11. Additional food items, such as vegetables, herbs, and the like, can be placed between or on the plurality of skewers 14 to cook alongside the food item 24. In this way, a user can cook an entire meal at the same time, or otherwise season or treat the food item 24 to increase the flavor thereof. Once the food item 24 is secured to the grilling tool 11, the user places the grilling tool 11 on the grill surface 23. Heat is transferred into the grilling tool 11 and through the plurality of skewers 14, evenly cooking the food item 24 thereon. The user then grips the handle 19 and removes the grilling tool 11 from the grill surface 23 once the food item 24 has reached the desired temperature. In some embodiments, the grilling tool 11 further comprises a thermometer configured to read the internal temperature of the food item 24 disposed on the plurality of skewers 14. In these embodiments, the thermometer is disposed within the plurality of skewers 14, wherein the thermometer is configured to detect the temperature of the food item 24 thereon and transmit the temperature to a display disposed on the planar base. The food item 24 is then removed from the skewers 14 to be consumed.

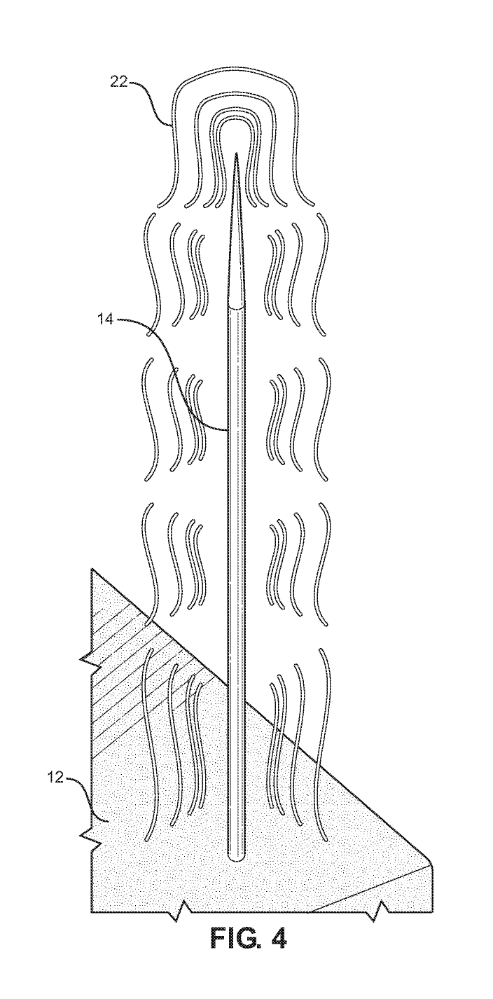

Referring now to FIG. 4, there is shown a close-up view of a skewer of an embodiment of the grilling tool radiating heat. Heat 22 is transferred from the planar base 12 to the plurality of skewers 14, wherein the heat 22 is then transferred out of the plurality of skewers 14 and into a food item disposed thereon. The plurality of skewers 14 comprise a material having a high heat transfer coefficient, such as aluminum, copper, and tungsten, however alternate materials having similar properties are contemplated, including alloys of the above listed materials. In this way, heat 22 can be transferred from the plurality of skewers 14 efficiently, such that food items placed thereon can be evenly cooked easily and quickly. In some embodiments, the planar base 12 comprises an igneous stone material, such as basalt, wherein the naturally porous nature of the igneous stone material allows the base to more efficiently retain heat 22, as the pockets of air disposed within the pores of the igneous stone act as insulators.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A grilling tool, comprising:
a planar base having an upper surface;
wherein the planar base comprises a stone material;
a plurality of skewers extending perpendicularly from the upper surface;
wherein the plurality of skewers taper from a first end thereof towards a second end thereof.

2) The grilling tool of claim 1, wherein the plurality of skewers are distributed across the upper surface in a grid pattern.

3) The grilling tool of claim 1, wherein the plurality of skewers are distributed across the upper surface in a staggered grid pattern.

4) The grilling tool of claim 1, further comprising a handle extending from a first side of the planar base.

5) The grilling tool of claim 4, wherein the handle further comprises a heat insulated gripping area.

6) The grilling tool of claim 1, wherein the plurality of skewers comprise a material selected from a group consisting of copper, tungsten, and aluminum.

7) The grilling tool of claim 1, wherein the planar base comprises an igneous stone material.
